(19) United States
(12) Patent Application Publication
(10) Pub. No.: US 2012/0072227 A1
(43) Pub. Date: Mar. 22, 2012

(54) AUTOMATICALLY GENERATING HIGH QUALITY SOA DESIGN FROM BUSINESS PROCESS MAPS BASED ON SPECIFIED QUALITY GOALS

(75) Inventors: Karthikeyan Ponnalagu, Tamil Nadu (IN); Renuka Sindhgatta Rajan, Bangalore (IN); Bikram Sengupta, Bangalore (IN)

(73) Assignee: INTERNATIONAL BUSINESS MACHINES CORPORATION, Armonk, NY (US)

(21) Appl. No.: 12/885,870

(22) Filed: Sep. 20, 2010

(51) Int. Cl. G06Q 10/00

(52) U.S. Cl. 705/1.1

(57) ABSTRACT

Methods and systems for automatically generating a service oriented architecture (SOA) design. A set of business process maps for the domain under consideration is defined and a design quality goal (function) that should be met (optimized) is specified. The design goal/function involves SOA metrics like coupling, cohesion, granularity, etc., which the system under consideration is pre-programmed to compute on any SOA design. The system takes as input the set of business process maps and the design quality goal/functions. It first generates semantic business process maps by identifying key concepts that occur in the task and business item descriptions. Next, it efficiently searches the service design space by starting with a seed design and employing a sequence of moves to iteratively optimize it. It outputs a set of possible SOA designs that meet the specified quality goals or optimizes the specified function, from where a user may select the final design.

### BACKGROUND

Generally, business process maps that include sequences of tasks, often across multiple hierarchies, provide one of the main inputs for service-oriented design. It is the responsibility of the SOA (service oriented architecture) designer to define an appropriate number of services, each including a logical grouping of operations that may be traced back to various process tasks. Given that tasks and business items are in natural language, and there can be innumerable ways in which operations may be grouped into services, a significant amount of human decision making is involved. Such designs are evaluated on the basis of a set of design attributes like coupling, cohesion, composability, reusability, granularity.

There are dependencies between these attributes, and an improvement in one dimension (e.g. cohesion) often leads to a deterioration along another (e.g. granularity). As a result, for large domains that include many business processes of non-trivial size, coming up with a high-quality SOA design is a major challenge requiring significant investment in time and human expertise. Moreover, business processes often undergo transformations to address new requirements, requiring updates to the SOA design model. It is difficult for a human expert to judge how to optimally update the design model to handle the new requirements. As a result, the design may deteriorate over time.

### BRIEF SUMMARY

In summary, one aspect of the invention provides a method comprising: assimilating a business process map; assimilating predetermined quality constraints; searching among service oriented architecture design models; and automatically yielding a service oriented architecture design model satisfying the predetermined quality constraints.

Another aspect of the invention provides an apparatus comprising: one or more processors; and a computer readable storage medium having computer readable program code embodied therewith and executable by the one or more processors, the computer readable program code comprising: computer readable program code configured to assimilate a business process map; computer readable program code configured to assimilate predetermined quality constraints; computer readable program code configured to search among service oriented architecture design models; and computer readable program code configured to automatically yield a service oriented architecture design model satisfying the predetermined quality constraints.

An additional aspect of the invention provides a computer program product comprising: a computer readable storage medium having computer readable program code embodied therewith, the computer readable program code comprising: computer readable program code configured to assimilate a business process map; computer readable program code configured to assimilate predetermined quality constraints; computer readable program code configured to search among service oriented architecture design models; and computer readable program code configured to automatically yield a service oriented architecture design model satisfying the predetermined quality constraints.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a computer system.

FIG. 2 schematically illustrates an arrangement for inputting business processes and yielding an SOA design.

FIG. 3 provides an example of a concept/action distribution table.

FIG. 4 sets forth a process more generally for generating an SOA design from business processes.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments of the invention. One skilled in the relevant art will recognize, however, that the various embodiments of the invention can be practiced without one or more of the specific details, or with other methods, components, materials, et cetera. In other instances, well-known structures, materials, or operations are not shown or described in detail to avoid obscuring aspects of the invention.

The description now turns to the figures. The illustrated embodiments of the invention will be best understood by reference to the figures. The following description is intended only by way of example and simply illustrates certain selected exemplary embodiments of the invention as claimed herein.

It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

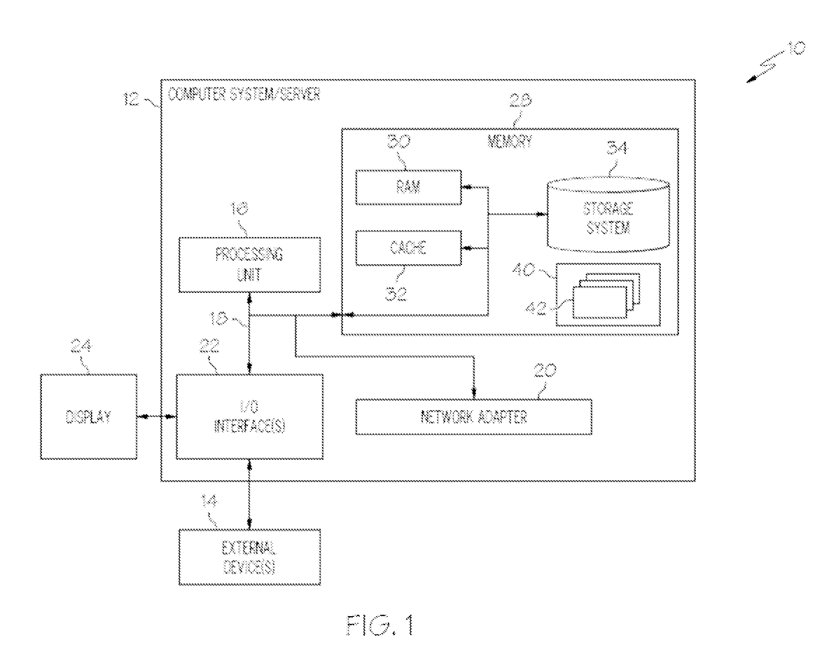

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

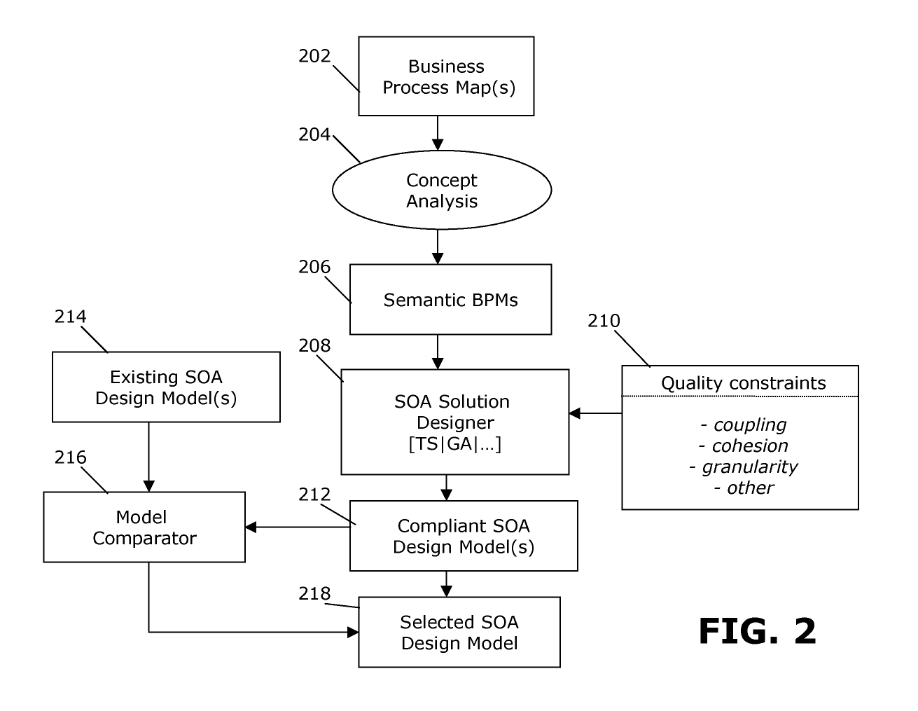

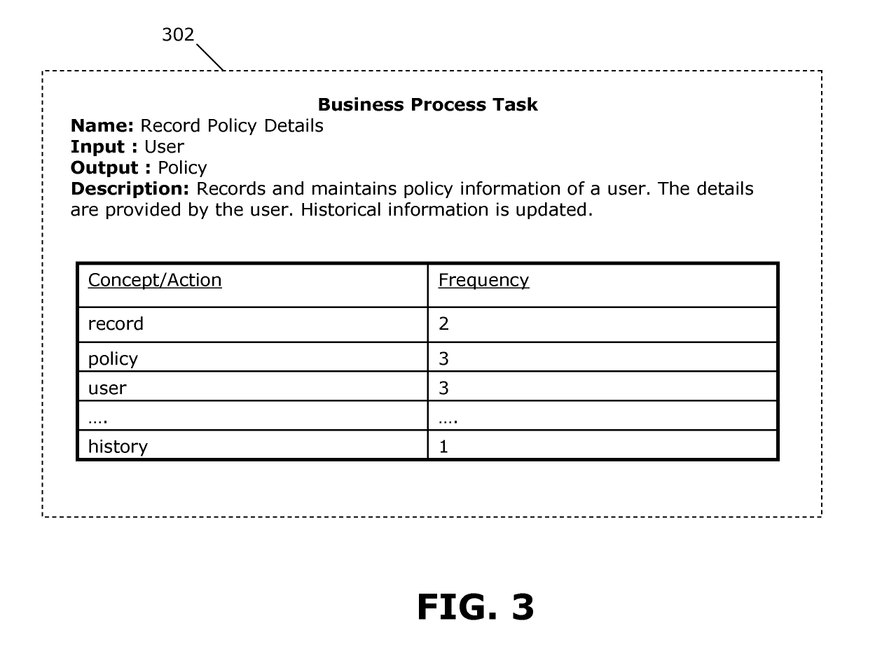

The disclosure now turns to FIGS. 2 and 3. It should be appreciated that the processes, arrangements and products broadly illustrated therein can be carried out on or in accordance with essentially any suitable computer system or set of computer systems, which may, by way of an illustrative and non-restrictive example, include a system or server such as that indicated at 12 in FIG. 1. In accordance with an example embodiment, most if not all of the process steps, components and outputs discussed with respect to FIGS. 2 and 3 can be performed or utilized by way of a processing unit or units and system memory such as those indicated, respectively, at 16 and 28 in FIG. 1, whether on a server computer, a client computer, a node computer in a distributed network, or any combination thereof.

Broadly contemplated herein, in accordance with at least one embodiment of the invention, are arrangements and methods for producing high quality SOA designs from business process maps with minimal human intervention.

In accordance with at least one embodiment of the invention, a system takes as input a set of business process maps from the domain, and a design quality function (involving metrics for multiple SOA attributes) that should be optimized. The system applies concept analysis techniques on task and business item descriptions to produce “semantic business process maps”, or “semantic BPM's”, where business tasks are tagged with the concepts that occur in them along with the frequency of occurrence. SOA quality goals are defined for semantic business process maps.

In accordance with at least one embodiment of the invention, the system thereupon efficiently searches the service design space by employing a set of search heuristics, which may be derived from the rich-body of algorithms that have been developed for solving combinatorial optimization problems (e.g. see Tabu Search, Genetic Algorithms etc., infra). The user can plug in a heuristic of his/her choice to drive the process. Moreover, the user can also specify certain constraints to limit the search space (e.g., maximum number of operations in a service, operations which should always be placed together in a service, etc). The output is a high-quality SOA design that optimizes the specified quality function over the design space searched.

Moreover, business processes undergo frequent transformations, and the system may be re-run whenever needed to generate a refined (optimal) design that may be obtained by making minimal changes to the existing design. In accordance with at least one embodiment of the invention, a prime advantage lies in the ability to auto-generate SOA design. Particularly, inasmuch as software/service design is generally considered to be a highly creative process requiring significant human expertise and involvement, an approach in accordance with at least one embodiment of the invention allows the process to be replaced by an automated mechanism. Advantages are also enjoyed in connection with the use of search heuristics in the realm of software/service design; this extension is significant in view of the standard use of search heuristics merely in solving combinatorial optimization problems.

FIG. 2 schematically illustrates an arrangement for inputting business processes and yielding an SOA design, in accordance with at least one embodiment of the invention.

In accordance with at least one embodiment of the invention, a set of one or more business process maps 202 is first assimilated from the domain at hand. The process then applies concept analysis techniques (204) on task and business item descriptions to produce “semantic BPM's” (semantic business process maps) 206, whereupon such semantic BPM's are tagged with the concepts that occur in them along with the frequency of occurrence.

In accordance with at least one embodiment of the invention, the semantic BPM's are then passed on to a SOA solution designer 208 The designer 208 starts with an initial seed design and then generates a sequence of moves to iteratively optimize the design, based on a set of quality constraints/objectives on SOA metrics 210 that are input. Such constraints 210 can include, but need not necessarily be limited to, coupling, cohesion, granularity, reusability, composability, and a very wide variety of other possible and suitable constraints.

In accordance with at least one embodiment of the invention, an overall search strategy for selecting a SOA solution may be guided by well-known heuristics like Tabu Search (TS), Genetic Algorithms (GA), or others. (See, e.g., Glover, F. and M. Laguna, Tabu Search, 1977, and Kluwer, Norwell, M A and Goldberg, David E., Genetic Algorithms in Search Optimization and Machine Learning, Addison Wesley, 1989. SOA solution designer 208 thereby outputs one or more compliant SOA design models 212.

In accordance with at least one embodiment of the invention, the output 218 is a high-quality SOA design that optimizes the specified quality function over the design space searched and either meets or comes close to desired quality levels chosen by the architect.

Some refinements and variants in accordance with at least one embodiment of the invention will now be discussed, along with additional details on various aspects of the example process illustrated in FIG. 2. Reference can continue to be made to FIG. 2 as well as to FIG. 3 as noted.

In accordance with at least one embodiment of the invention, and as will be appreciated more fully further below, a user can interact with the system to add/edit constraints and further fine-tune the solution. Inasmuch as business processes undergo frequent transformations, the system may be re-run whenever needed to produce a refined (currently compliant) design 212. Given an existing design 214 and a set of transformed business process maps, the system will produce an updated design that will require minimal changes to the existing design. This will be produced by leveraging a model comparator 216 that can be based on well-know techniques like MoJo (See, for example, Tzerpos, V. and Holt, R. C., “MoJo: A Distance Metric for Software Clusterings”, In Proceedings of the Sixth Working Conference on Reverse Engineering (October 06-08, 1999), WCRE, IEEE Computer Society, Washington, D.C., 187.)

Generally, a business process map (202) may be understood to include, in accordance with at least one embodiment of the invention: a sequence of tasks; task definitions and/or task names; input and output business items for the tasks; task and business item descriptions.

In accordance with at least one embodiment of the invention, concept analysis 204 involves extracting each task of the business process map(s) 202 as well as meta-data which includes task definitions and input and output business items. Also extracted is any additional information on the business domain of the tasks (e.g., Claim Administration, Customer Relationship, Employee Management, etc.).

Concept analysis 204, in accordance with at least one embodiment of the invention, involves extracting key concepts and actions from the meta-data. To this end, text processing techniques such as tokenization, stemming and parts of speech analysis to extract the “concepts” (nouns) and “actions” (verbs) in the meta-data

Concept analysis 204, in accordance with at least one embodiment of the invention, further involves identifying the distribution of concepts from the task description and meta-data and define a concept/action distribution table. To this end, a distribution of concepts from the description of tasks and meta-data may be identified while for task recode policy details, a concept distribution based on description and meta-data can be identified. An example of a concept/action distribution table 302 is shown in FIG. 3. In table 302, a first column, “Concept/action”, includes labels “record”, “user”, “policy” and “history” while a second column, “Frequency” indicates frequency of occurrence as discussed heretofore. Additionally, concept analysis 204, in accordance with at least one embodiment of the invention, involves associating each task with the concept/action distribution table (302 in FIG. 3) to arrive at semantic business maps 206.

In accordance with at least one embodiment of the invention, solution designer 208 acts to define an SOA quality goal based on a set of quality definitions (or constraints 210) and trade-offs. Examples of quality definitions (QD's) can include, e.g.:
Service granularity should be high, for easier governance and maintenance. For instance, all services should have high granularity
Services should be highly cohesive. For instance, 80% of the services should have high cohesion
Services should have low coupling. For instance, 60% of the services should have low message coupling
Limit the number of services in the design to 50. One such definition of quality metrics for coupling, cohesion, granularity is provided in Sindhgatta, R., Sengupta, B., and Ponnalagu, K, “Measuring the Quality of Service Oriented Design”, Proceedings of the 7th international Joint Conference on Service-Oriented Computing, 2009.

A composite quality goal may also be specified as a function of different quality definitions. For instance, a SOA design quality goal can be expressed as F{QD₁ . . . QDₙ}, where each QDᵢ is a quality definition. Such quality definitions can include particular thresholds or ranges relating to any or all of the quality constraints 210. For example, one quality definition could be that “60% of the services must have low coupling and high cohesion” while another could be, “limit the number of services to 50”.

In accordance with at least one embodiment of the invention, it is also possible for solution designer 208 to assign weights and prioritize individual quality definitions, with quality constraints 210 having been assimilated to that end. In accordance with at least one embodiment of the invention, metrics help in quantifying quality attributes of a service and can include, but need not be limited to:
Cohesion (SFCI). This is a measure of the ratio of operations that process/work on similar messages and contained types (representative of the domain entities) to the total number of service operations.
Coupling. A Service Operational Coupling Index (SOCI) measures the dependence of a service on operations of other services. An Inter-Service Coupling Index (ISCI) measures the dependence of a service on other services. A Service Message Coupling Index (SMCI) measures the dependence of a service on the message and data types derived from the information model of the domain.
Granularity. Service Capability Granularity (SCG) is the number of operations of a service, while Service Data Granularity (SDG) is the number of messages on which the service operates.
Composability. SCOMP (Service COMPosability) is the measure of distinct composition participants that precede of succeed a service in its compositions.
Reusablity. SRI (Service Reusability Index) Measures the number of consumers of a service, while ORI (Operation Reusability Index) measures the number of consumers of the operation of a service.

In accordance with at least one embodiment of the invention, solution designer 208 maps service quality goals to the semantic BPM's 206. Thus, inasmuch as a service includes operations, each operation maps to a business tasks A service can be understood to be a group or cluster of business tasks.

In accordance with at least one embodiment of the invention, service cohesion represents business tasks that have similar concept distribution tables, wherein similarity can be defined on the basis of such measures as a cosine measure.

In accordance with at least one embodiment of the invention, service coupling refers to business tasks across service groups having similar concept tables. Higher coupling would indicate a lower inter-group concept cosine measure distance.

In accordance with at least one embodiment of the invention, service granularity refers to a number of business tasks grouped together as a services, and a number of business items used by the group of business tasks.

In accordance with at least one embodiment of the invention, service reusability refers to a number of processes in which the business tasks are used.

In accordance with at least one embodiment of the invention, search techniques to arrive at the service design (218) can be implemented as follows. Start by identifying each task as a service with one operation. This would be done for the number of services required to be designed. Next, assign additional tasks to the service based on the concept similarity measure and also based on other constraints (e.g., number of tasks that can be assigned and number of distinct business items in the group). Additionally, define an objective function that maximizes the concept similarity of each service (e.g., group/cluster of tasks) and solve the function through an optimization/search engine such that only tasks that improve the similarity distance are moved and that constraints on other metrics (such as coupling , granularity, e.g.) are satisfied for a given move of the task to a given service group. Then, converge at the best solution that groups business tasks into services meeting the goals.

Change management, or change in service design based on changes to business process maps, can be handled in essentially any suitable manner in accordance with at least one embodiment of the invention. Generally, a business process may undergo changes for any of a wide variety of reasons, e.g., enterprise processes and requirements may change. Thus, in accordance with the sample embodiment of FIG. 2, existing model 214 is regenerated with a new process change, via employing a model comparator 216. The model comparator 216 compares a currently compliant model 212 with an existing SOA design model 214 (i.e., a model incorporating an older or previous design) to ascertain the change required. If a change is required, then this gets forwarded as the selected design model 218. Techniques such as MoJo (See Tzerpos et al., supra) can be used to compare software clusters (e.g., business task clusters).

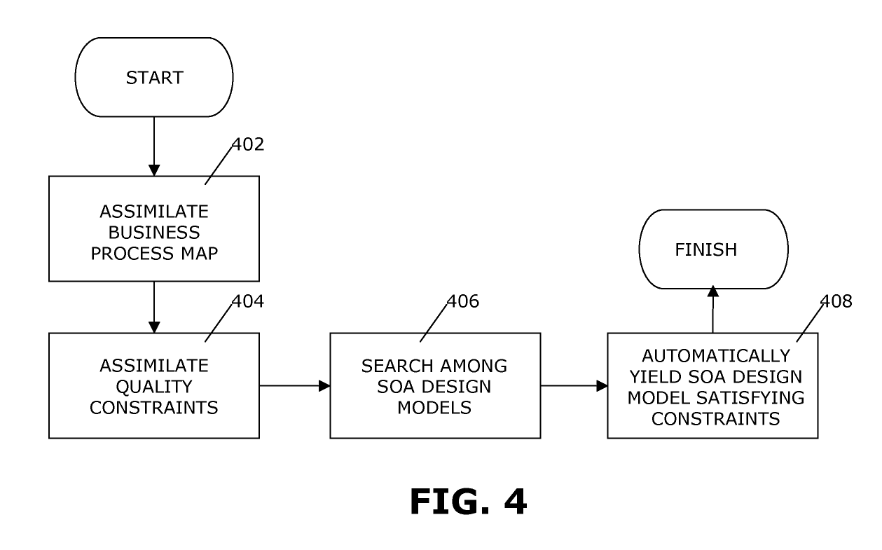

FIG. 4 sets forth a process more generally for generating an SOA design from business processes, in accordance with at least one embodiment of the invention. It should be appreciated that a process such as that broadly illustrated in FIG. 4 can be carried out on essentially any suitable computer system or set of computer systems, which may, by way of an illustrative and on-restrictive example, include a system such as that indicated at 12 in FIG. 1. In accordance with an example embodiment, most if not all of the process steps discussed with respect to FIG. 4 can be performed by way a processing unit or units and system memory such as those indicated, respectively, at 16 and 28 in FIG. 1.

As shown in FIG. 4, a business process map is assimilated (402) along with predetermined quality constraints (404). A search is performed among service oriented architecture design models (406), and a service oriented architecture design model satisfying the predetermined quality constraints is yielded (408).

In brief recapitulation, it will be appreciated that there are broadly contemplated herein, in accordance with at least one embodiment of the invention, methods and systems for automatically generating a high quality service oriented architecture (SOA) design. A set of business process maps for the domain under consideration is defined and a design quality goal (function) that should be met (optimized) is specified. The design goal/function involves SOA metrics like coupling, cohesion, granularity etc., which the system under consideration is pre-programmed to compute on any SOA design. The system takes as input the set of business process maps and the design quality goal/functions. It first generates semantic business process maps by identifying key concepts that occur in the task and business item descriptions. Next, it efficiently searches the service design space by starting with a seed design and employing a sequence of moves to iteratively optimize it. It outputs a set of possible SOA designs that meet the specified quality goals or optimizes the specified function, from where a user may select the final design. The methods and systems can also update an existing design, where the system takes as input an existing SOA design, along with a set of (transformed) business process maps and a design quality goal/function. It automatically generates a set of possible SOA designs as above, and then applies model comparison techniques to determine the new design that may be obtained through minimal changes to the existing design.

It should be noted that aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the invention may be written in any combination of one or more programming languages, including an object oriented programming language such as Java®, Smalltalk, C++or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

What is claimed is:

1. A method comprising:
assimilating a business process map;
assimilating predetermined quality constraints;
searching among service oriented architecture design models; and
automatically yielding a service oriented architecture design model satisfying the predetermined quality constraints.

2. The method according to claim 1, wherein the business process map includes a sequence of tasks and task definitions.

3. The method according to claim 2, wherein the business process map further includes input and output business items for the tasks.

4. The method according to claim 1, further comprising generating a semantic business process map prior to said searching.

5. The method according to claim 4, wherein said generating comprises extracting one or more tasks and meta-data from the business process map.

6. The method according to claim 5, wherein the meta-data includes task definitions and input and output business items.

7. The method according to claim 5, wherein said generating further comprises extracting key concepts and actions from the meta-data.

8. The method according to claim 5, wherein said generating further comprises defining a concept/action distribution table.

9. The method according to claim 8, wherein said generating further comprises associating each task with the concept/action distribution table.

10. The method according to claim 1, wherein said yielding comprises determining a quality goal based on one or more predetermined quality definitions.

11. The method according to claim 10, wherein the one or more predetermined quality definitions are related to the assimilated quality constraints.

12. The method according to claim 11, wherein the predetermined quality constraints are based on one or more variables taken from the group consisting essentially of: cohesion; coupling; granularity; composability; and reusability.

13. The method according to claim 1, further comprising:
assimilating a revised quality constraint or revised business process map;
yielding a new service oriented architecture design model;
comparing the service oriented architecture design model with the new service oriented architecture design model; and
automatically selecting a final yielded service oriented architecture design model based on said comparing.

14. An apparatus comprising:
one or more processors; and
a computer readable storage medium having computer readable program code embodied therewith and executable by the one or more processors, the computer readable program code comprising:
computer readable program code configured to assimilate a business process map;
computer readable program code configured to assimilate predetermined quality constraints;
computer readable program code configured to search among service oriented architecture design models; and
computer readable program code configured to automatically yield a service oriented architecture design model satisfying the predetermined quality constraints.

15. A computer program product comprising:
a computer readable storage medium having computer readable program code embodied therewith, the computer readable program code comprising:
computer readable program code configured to assimilate a business process map;
computer readable program code configured to assimilate predetermined quality constraints;
computer readable program code configured to search among service oriented architecture design models; and
computer readable program code configured to automatically yield a service oriented architecture design model satisfying the predetermined quality constraints.

16. The computer program product according to claim 15, wherein the business process map includes a sequence of tasks and task definitions.

17. The computer program product according to claim 15, wherein said computer readable program code is further configured to generate a semantic business process map prior to said searching.

18. The computer program product according to claim 17, wherein said computer readable program code is configured to extract one or more tasks and meta-data from the business process map.

19. The computer program product according to claim 18, wherein said computer readable program code is further configured to extract key concepts and actions from the meta-data.

20. The computer program product according to claim 18, wherein said computer readable program code is further configured to define a concept/action distribution table.

21. The computer program product according to claim 20, wherein said computer readable program code is further configured to associate each task with the concept/action distribution table.

22. The computer program product according to claim 15, wherein said computer readable program code is configured to determine a quality goal based on one or more predetermined quality definitions.

23. The computer program product according to claim 22, wherein the one or more predetermined quality definitions are related to the assimilated quality constraints.

24. The computer program product according to claim 23, wherein the predetermined quality constraints are based on one or more variables taken from the group consisting essentially of: cohesion; coupling; granularity; composability; and reusability.

25. The computer program product according to claim 15, wherein said computer readable program code is further configured to:
assimilate a revised quality constraint or revised business process map;
yield a new service oriented architecture design model;
compare the service oriented architecture design model with the new service oriented architecture design model; and
automatically select a final yielded service oriented architecture design model based on the comparing.
